(19) United States
(12) Patent Application Publication
(10) Pub. No.: US 2024/0264463 A1
(43) Pub. Date: Aug. 8, 2024

(54) PAIR OF EYEGLASSES AND METHOD FOR MANUFACTURING PAIR OF EYEGLASSES

(71) Applicant: Yiwu Shangwei Import&Export Co., Ltd., Yiwu City (CN)

(72) Inventor: Xiaolin Lu, Yiwu City (CN)

(21) Appl. No.: 18/105,168

(22) Filed: Feb. 2, 2023

(51) Int. Cl. G02C 5/12; G02C 3/00

(52) U.S. Cl. CPC G02C 5/12; G02C 3/003; G02C 2200/06; G02C 2200/20

(57) ABSTRACT

The present disclosure is applicable to the technical field of glasses and provides an pair of eyeglasses, the pair of eyeglasses includes an eyeglass frame surrounding a pair of lenses of the pair of the eyeglasses; at least one nose pad arranged on the eyeglass frame, and molded integrally with the eyeglass frame, a material of the nose pad being different from a material of the eyeglass frame; a reinforcing member extending out of one of the nose pad and a portion of the eyeglass frame corresponding to the nose pad; and a matching member formed on the other one of the nose pad and the eyeglass frame, and the reinforcing member is coupled with the matching member.

### TECHNICAL FIELD

The disclosure relates to the technical field of eyeglasses, and in particular, to an pair of eyeglasses and method for manufacturing pair of eyeglasses.

### BACKGROUND

Eyeglasses comprise a frame, lenses, etc. Edges on both sides of the frame are respectively connected with a mirror leg frame on an auricle, and a nose pad is supported by a nose bridge for support. the eyeglasses can improve the vision of the wearer, protect the eyes, but also for decoration and other purposes.

After wearing eyeglasses for a period of time, the two sides of the nose bridge of the wearer may become red and swollen, leaving indentation. However, the user who need vision correction may not take of the eyeglasses and need to continue wearing the eyeglasses for a long time, which makes the indentation difficult to fade. In the prior art, most of the soft nose pads are installed separately to improve the comfort of the wearer. However, after wearing eyeglasses for a long time, there will still be indentation on the nose bridge even with the nose pads. Most of the nose pads on the market are fixed and installed by screws, which can be shaken and fall off easily, and the reinstallation process is complex.

### SUMMARY OF INVENTION

The embodiment of the present disclosure is to provide a pair of eyeglasses, so as to solve the problems existing in the described background art.

In order to solve the above technical problem, the present disclosure provides an pair of eyeglasses, the pair of eyeglasses comprising: an eyeglass frame surrounding a pair of lenses of the pair of the eyeglasses; at least one nose pad arranged on the eyeglass frame, and molded integrally with the eyeglass frame, a material of the nose pad being different from a material of the eyeglass frame; a reinforcing member extending out of one of the nose pad and a portion of the eyeglass frame corresponding to the nose pad; and a matching member formed on the other one of the nose pad and the eyeglass frame, and the reinforcing member is coupled with the matching member.

Preferably, the reinforcing member comprises a plurality of protrusions arranged at intervals, and the matching member has corresponding indentations to accommodate the plurality of barbs.

Preferably, each of the protrusions comprises a post and a hook, the post is coupled to one of the nose pad and the eyeglass frame, and the hook is coupled to an end portion of the post away from one of the nose pad and the eyeglass frame.

Preferably, the plurality of protrusions are arranged in at least two lines, and the protrusions of adjacent two of the lines are staggered.5.

The pair of eyeglasses according to claim 1, wherein the reinforcing member comprises at least one reinforcing rib, the at least one reinforcing rib extends along an extending direction of the portion of the eyeglass frame, and the matching member comprises corresponding indentations to accommodate the at least one reinforcing rib.

Preferably, the eyeglass frame further comprises at least one notch formed on the portion of the eyeglass frame, the notch comprises a first surface lower than a second surface of the eyeglass frame, the notch is configured to receiving the nose pad, and the reinforcing member is formed at the notch.

Preferably, further comprising a pair of temples rotatably disposed at the ends of both sides of the eyeglass frame; a pair of connection buckles; and an adjustment belt, wherein the pair of connection buckles are respectively arranged at one end of the pair of temples away from the eyeglass frame, and two ends of the adjustment belt are respectively connected to the pair of connection buckles.

Preferably, the nose pad is formed by thermal fusion of latex, silica gel and organic polysiloxane catalyst.

Preferably, the material of the nose pad comprises the following components mixed by weight ratios: 15-25% of latex, 75-85% of silica gel, and 0.8-1.2% of catalyst.

Preferably, the catalyst comprises an organic polysiloxane with at least two alkenyl groups per molecule.

In order to solve the above technical problem, the present disclosure provides a method for manufacturing a pair of eyeglasses, the pair of eyeglasses comprising an eyeglass frame and at least one nose pad configured for supporting the eyeglass or the eyeglass frame on a nose of a wearer, the method comprising: forming an eyeglass frame with a reinforcing member extending out a portion of the eyeglass frame by a molding injecting process, wherein the eyeglass frame is made of a first material; and simultaneously forming the at least one nose pad corresponding to the portion of the eyeglass frame wherein the reinforcing member is positioned during the molding injection process, wherein the at least one nose pad is made of a second material different from the first material, the at least one node pad is formed with a matching member to couple to the reinforcing member.

Preferably, forming an eyeglass frame with a reinforcing member extending out a portion of the eyeglass frame using a molding injecting process comprises: providing a first mold configured for the eyeglass frame and the nose pad; injecting a first material into the first mold, wherein the first material is at high-temperature and in liquid state; and controlling the temperature of the first material in the first mold to maintain the first material in a pasty state, and wherein simultaneously forming the at least one nose pad corresponding to the portion of the eyeglass frame wherein the reinforcing member is positioned during the molding injection process comprises: injecting a second material into the first mold, and fused the second material with the first material by hot melting to complete a secondary injection molding to form the nose pad, wherein the second material is in a liquid state, and demolding and trimming after cool molding.

Preferably, further comprising: providing a second mold configured for temples; injecting a third material into the second mold, wherein the third material is in a liquid state; demolding and trimming after cool molding to form the temples; and assembling the eyeglass frame and the temples together, and assembling a pair of lenses to form the pair of eyeglasses.

Preferably, the first material comprises nylon, a temperature of the first material in liquid state is in a range of 220-265° C., and a temperature for maintaining the pasty state is controlled at a range of 160-170° C.

Preferably, the second material comprises a following components mixed by weight ratio: 15-25% of latex, 75-85% of silica gel, and 0.8-1.2% of catalyst.17.

Preferably, the second material comprises a following components mixed by weight ratio: 19% of latex, 80% of silica gel, and 1% of catalyst.

Preferably, the catalyst comprises an organic polysiloxane with at least two alkenyl groups per molecule.

Preferably, the temperature of the second material in the liquid state is in a range of 160-220° C.

The pair of eyeglasses provided by the embodiment of the present disclosure use a nose pad instead of the traditional nose pad, which is made of silica gel and latex, with high comfort and simple structure, better support and comfort to the nose bridge, and will not produce indentation even if it is worn for a long time. At the same time, The pair of eyeglasses frame and the nose pad are integrally formed, the mounting groove on the eyeglass frame and the connecting fixing member are matched, so that the nose pad is injection molded on the mounting groove. At the same time, the connecting fixing member is embedded in the nose pad, which has good adhesiveness and packaging, is not only aesthetic, but also prevents the nose pad from falling off. In the production process, it adopts secondary injection molding, integrated molding, and simple production process.

### BRIEF DESCRIPTION OF DRAWINGS

FIG. 1 is a structural schematic diagram of a pair of eyeglasses provided by an embodiment of the present disclosure.

FIG. 2 is another structural schematic diagram of the pair of eyeglasses provided by the embodiment of the present disclosure.

FIG. 3 is a sectional view of the pair of eyeglasses in FIG. 2 along line III-III.

FIG. 4 is a structural schematic diagram of a connecting fixing member in the pair of eyeglasses provided by an embodiment of the present disclosure.

FIG. 5 is an enlarged structural schematic diagram of portion A in FIG. 4.

FIG. 6 is a sectional view of the pair of eyeglasses, corresponding to FIG. 3.

FIG. 7 is another structural schematic diagram of the connecting fixing member in the pair of eyeglasses provided by an embodiment of the present disclosure.

FIG. 8 is an enlarged structural diagram of portion B in FIG. 7.

FIG. 9 is a flow chart of a method for manufacturing pair of eyeglasses.

FIG. 10 is the detailed flow chart of step S100 in FIG. 9.

FIG. 11 is the detailed flow chart of step S200 in FIG. 9.

### DETAILED DESCRIPTION

To make the objectives, technical solutions, and advantages of the present disclosure clearer, the following further describes the present disclosure in detail with reference to the accompanying drawings and embodiments. It should be understood that the embodiments described herein are only intended to explain the present disclosure, but not to limit the present disclosure.

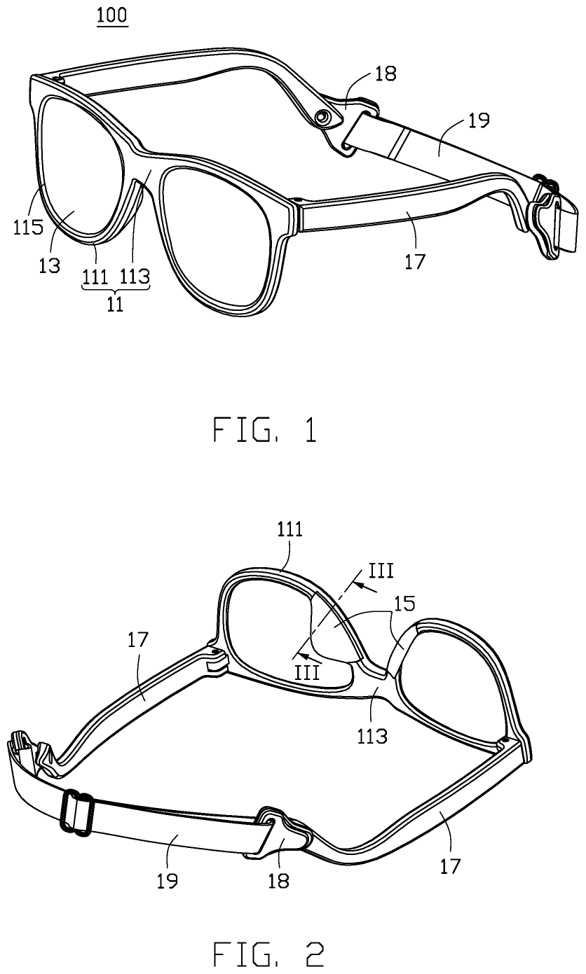

Referring to FIG. 1 and FIG. 2, the present disclosure provides a pair of eyeglasses 100. the pair of eyeglasses 100 comprise an eyeglass frame 11, a pair of lenses 13, at least one nose pad 15, and a pair of temples 17.

The eyeglass frame 11 surrounds the pair of lenses 13. Specifically, the eyeglass frame 11 comprises two peripheral portions 111 and a connecting portion 113. Each of the peripheral portions 111 defines a receiving hole 115 for receiving corresponding lens 13. A fixing structure (not show) for fixing the lens 13 is formed on an inner side of the peripheral portion 111, so that the pair of lenses 13 can be embedded in the eyeglass frame 11. the connecting portion 113 is located between two peripheral portions 111, and both ends are connected with the peripheral portions 111.

The nose pad 15 is configured for supporting the eyeglass on user's nose and arranged on the eyeglass frame 11. the nose pad 15 is molded integrally with the eyeglass frame 11, a material of the nose pad 15 is different from a material of the eyeglass frame 11. In this embodiment, the nose pad 15 is formed by thermal fusion of latex, silica gel and organic polysiloxane catalyst. Further, the material of the nose pad comprises the following components mixed by weight ratios: 15-25% of latex, 75-85% of silica gel, and 0.8-1.2% of catalyst, and the catalyst comprises an organic polysiloxane with at least two alkenyl groups per molecule.

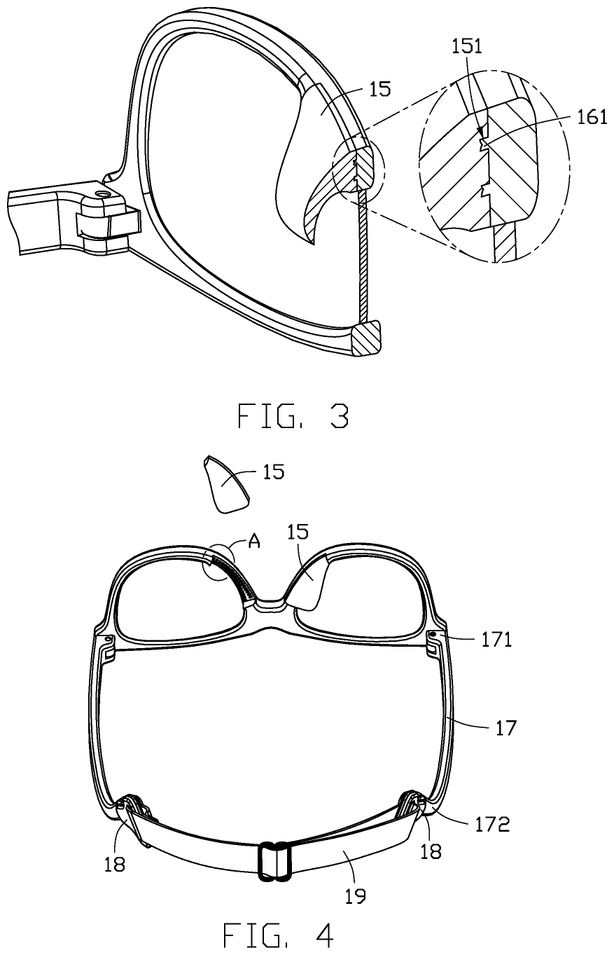

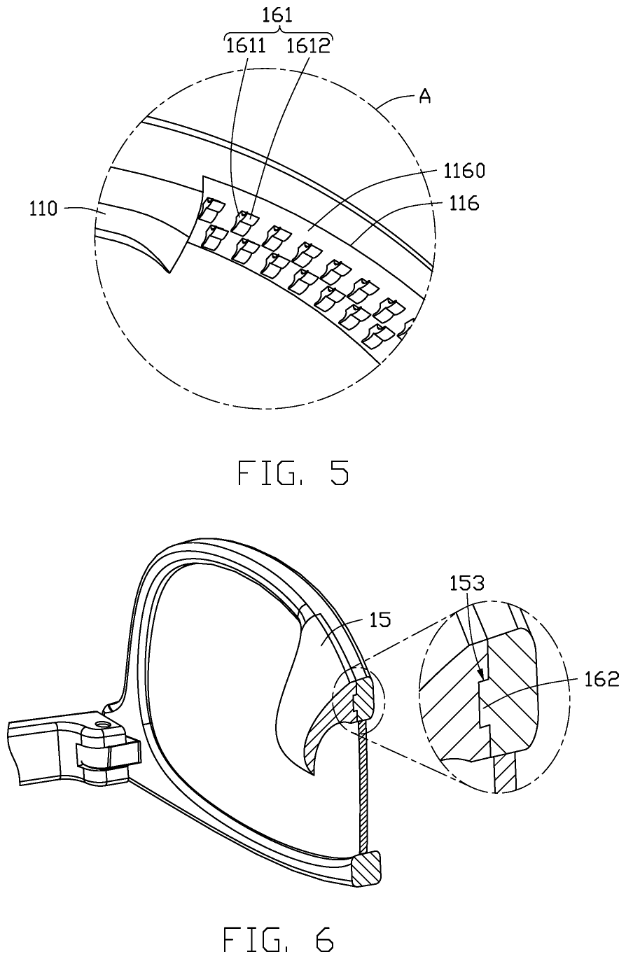

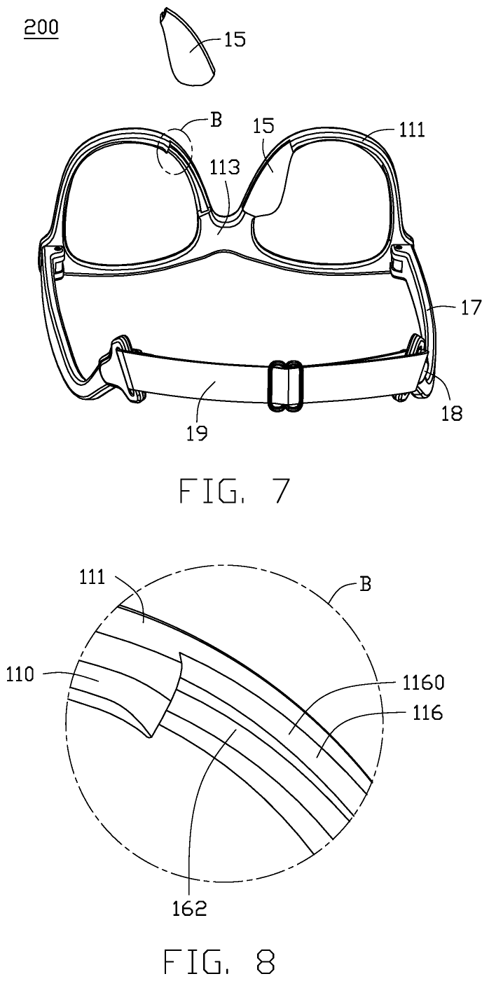

In addition, referring to FIG. 3 to FIG. 5, a reinforcing member extending out of one of the nose pads 15 and a portion of the eyeglass frame 11 corresponding to the nose pads 15, a matching member 151 formed on the other one of the nose pads 15 and the eyeglass frame 11, and the reinforcing member is coupled with the matching member 151. The portion is at least a part of the peripheral portions 111 and the connecting portion 113.

In this embodiment, the reinforcing member comprises a plurality of protrusions 161 arranged at intervals, and the matching member 151 has corresponding indentations to accommodate the plurality of protrusions 161. the plurality of the protrusions 161 are arranged in at least two lines, and the protrusions 161 of adjacent two of the lines are staggered, so as to further reinforce the fixed connection between at least one nose pad 15 and the eyeglass frame 11. Each of the protrusions 161 comprises a post 1611 fixed to the surface of the notch 116 and a hook 1612. The post 1611 is coupled to one of the nose pad 15 and the eyeglass frame 11, and the hook 1612 is coupled to an end portion of the post 1611 away from one of the nose pad 15 and the eyeglass frame 11.

In this embodiment, the eyeglass frame 11 further comprises at least one notch 116 which is formed on the portion of the eyeglass frame 11, the notch 116 comprises a first surface 1160 lower than a second surface 110 of the eyeglass frame 11 and is configured to receiving the nose pad 15, and the reinforcing member is formed at the notch 116.

The nose pad 15 is subjected to secondary injection moulding on the notch 116 and hot melt adhesion. The protrusions 161 is embedded in the matching member 151 of the nose pads 15. Thus, the nose pad 15 have good viscosity and can firmly wrap the protrusions 161, thereby not only being attractive, but also avoiding falling of at least one nose pad 15.

In addition, the number of protrusions 161 is not less than 30, so that the connection between the nose pad 15 and the eyeglass frame 11 is more secure. Of course, the number of the protrusions 161 can be adjusted according to requirements, which is not limited here.

Although this embodiment exemplifies providing protrusions 161 on the surface of the notch 116, in other embodiments, the protrusions 161 can also be provided on the nose pad 15, which is not limited herein.

In this embodiment, the pair of eyeglasses 100 comprise a pair of nose pads 15, and the pair of nose pads 15 are respectively arranged on one side of the peripheral portion 111 near the connecting portion 113.

In place of the traditional nose pad, better support and comfort for the nose bridge when worn. Meanwhile, the nose pads 15 and the eyeglass frame 11 are integrally formed, thereby improving the connection strength between the eyeglass frame 11 and the nose pads 15 and preventing the nose pads 15 from falling off.

Although the pair of nose pads 15 are separately provided, but in other embodiments, the pair of nose pads 15 maybe continuously provided on the peripheral portion 111 and/or the connecting portion 113 without interruption, which is not limited herein.

The pair of temples 17 are rotatably disposed at the ends of both sides of the eyeglass frame 11. Further, the pair of temples 17 are connected to the ends of both sides of the eyeglass frame 11 through hinges, so that the temple 17 can be unfolded or folded. In the present embodiment, each temple 17 comprises a first end 171 and a second end 172, wherein the first end 171 is rotatably fixed at an end portion of the eyeglass frame 11, and the second end 172 is an end of the temple 17 away from the eyeglass frame 11.

Further, the pair of eyeglasses 100 further comprise a pair of connection buckles 18 and an adjustment belt 19, in which the pair of connection buckles 18 are provided and are respectively connected to the second end 172 of the temples 17, the pair of connection buckles 18 are connected via the adjustment belt 19; and the tightness of wearing can be adjusted by means of the adjustment belt 19. In particular, for user with a relatively small head shape, the adjustment belt 19 can prevent the pair of eyeglasses from falling off.

In other embodiments, the pair of connection buckles 18 and the adjustment belt 19 may also be omitted, which is not limited herein.

Performance Testing:

A portion of the nose pad 15 is pulled by a force of 90 N for more than 10 seconds, and the nose pad 15 does not fall off.

### Second Embodiment

The second embodiment of the present disclosure will be described with reference to FIG. 5 and FIG. 6. For the convenience of description, members having the same functions as those of the members described in the above embodiment will be given the same reference numerals, and the description thereof will be omitted.

The pair of eyeglasses 200 of the present embodiment differs from the pair of eyeglasses 100 of the first embodiment only in the structure of the reinforcing member, and other structures are the same as those of the pair of eyeglasses 100 of the first embodiment and will not be described in detail here. the reinforcing member comprises at least one reinforcing rib 162, the at least one reinforcing rib 162 extends along an extending direction of portion of the eyeglass frame 11, and the matching member 153 has corresponding structures to accommodate the at least one reinforcing rib 162.

Performance Testing:

A portion of the nose pad 15 is pulled by a force of 90 N for more than 10 seconds, and the nose pad 15 does not fall off.

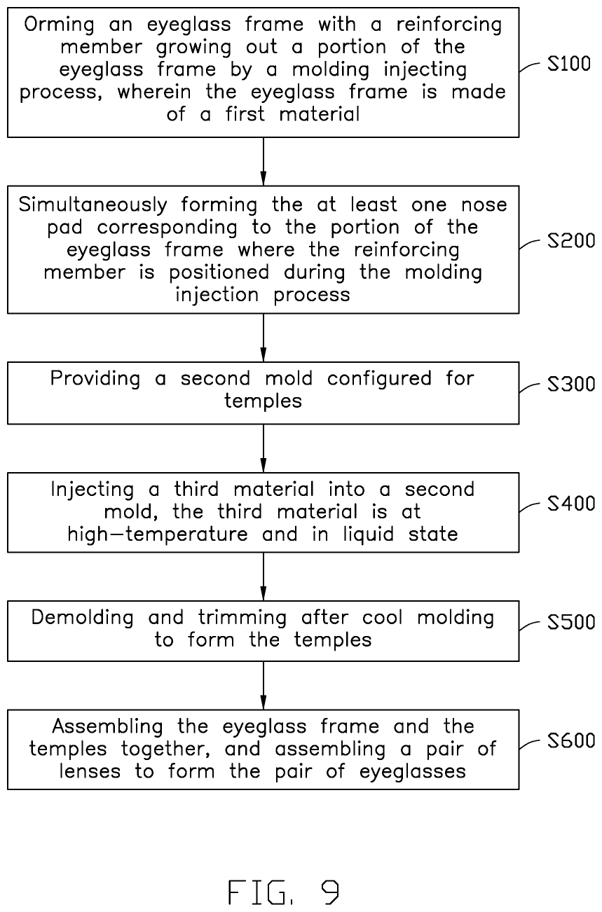

Referring to the FIG. 9, the present disclosure further provides a method for manufacturing pair of eyeglasses, the pair of eyeglasses comprise an eyeglass frame and at least one nose pad configured for supporting the eyeglass or the eyeglass frame on a nose of a wearer, the method comprises:

Step 100, forming an eyeglass frame with a reinforcing member growing out a portion of the eyeglass frame by a molding injecting process, wherein the eyeglass frame is made of a first material; and

Step 200, simultaneously forming the at least one nose pad corresponding to the portion of the eyeglass frame where the reinforcing member is positioned during the molding injection process, wherein the at least one nose pad is made of a second material different from the first material, the at least one node pad is formed with a matching member to couple to the reinforcing member.

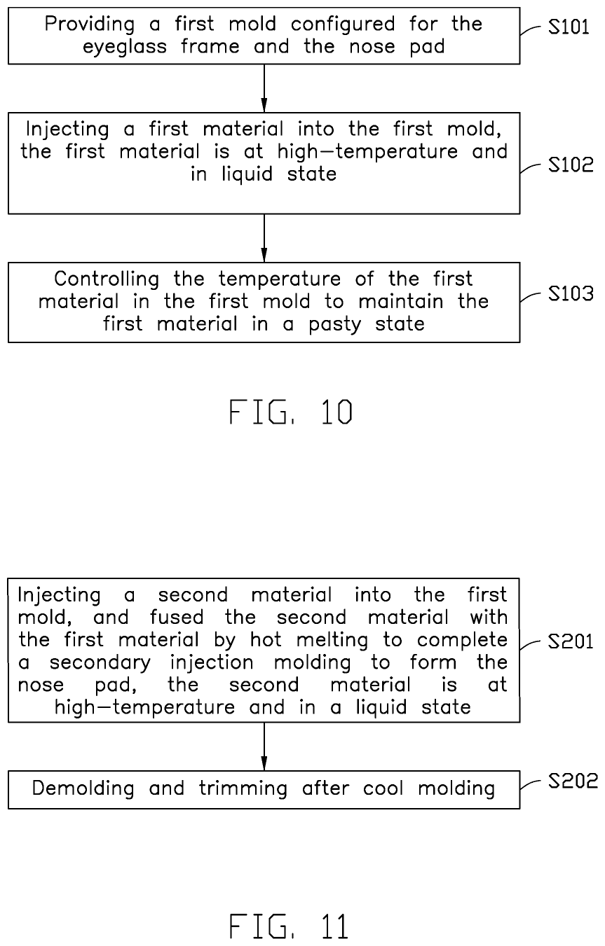

In addition, referring to the FIG. 10, forming an eyeglass frame with a reinforcing member extending out a portion of the eyeglass frame using a molding injecting process comprises:

Step 101, providing a first mold configured for the eyeglass frame and the nose pad;

Step 102, injecting a first material into the first mold, the first material is at high-temperature and in liquid state; and

Step 103, controlling the temperature of the first material in the first mold to maintain the first material in a pasty state.

Referring to the FIG. 11, the step of simultaneously forming the at least one nose pad corresponding to the portion of the eyeglass frame wherein the reinforcing member is positioned during the molding injection process comprises:

Step 201, injecting a second material into the first mold, and fused the second material with the first material by hot melting to complete a secondary injection molding to form the nose pad, the second material is at high-temperature and in a liquid state, and

Step 202, demolding and trimming after cool molding.

The first material comprises nylon, the temperature of the first material at high-temperature and in liquid state is in a range of 220-265° C., and the temperature for maintaining the pasty state is controlled at a range of 160-170° C.

After the injection molding is completed with the first material, the temperature is controlled to keep the first material in a pasty state, the while the second material is continuously injected, that is when the first material is not completely cooled during the first injection molding, the second injection molding is carried out immediately and then the cooling is quickly completed. In this way, the fusion between the first material and the second material can be effectively completed without delamination and peeling, so that the nose pad can be firmly set on the eyeglass frame.

In addition, the second material comprises the following components mixed by weight ratios: 15-25% of latex, 75-85% of silica gel, and 0.8-1.2% of catalyst.

In addition, the catalyst comprises an organic polysiloxane with at least two alkenyl groups per molecule.

In addition, the temperature of the second material in a high-temperature liquid state is in a range of 160-220° C.

In addition, the method further comprises:

Step 300, providing a second mold configured for temples;

Step 400, injecting a third material into a second mold, the third material is at high-temperature and in liquid state;

Step 500, demolding and trimming after cool molding to form the temples; and

Step 600, assembling the eyeglass frame and the temples together, and assembling a pair of lenses to form the pair of eyeglasses.

In addition, the third material comprises a thermoplastic elastomer, and the temperature of the third material at high-temperature and in liquid state is in a range of 220-240° C.

The following describes specific embodiments.

### Embodiment 1

A method for manufacturing the pair of eyeglasses, comprising the following steps:

Injecting a first material into the first mold, the first material is at high-temperature and in liquid state, and controlling the temperature of the first material so as to maintain the first material in a pasty state, a notch and a plurality of barbs are reserved on the eyeglass frame, continuously injecting a second material into the first mold, the second material is at high-temperature and in liquid state, so that at least one nose pad and the eyeglass frame can be fused by thermal fusion, completing secondary injection molding of at least one nose pad, and at least one nose pad is injected into the notch, the plurality of barbs are embedded in at least one nose pad to form fixation, and demolding and trimming after cool molding;

Injecting a high-temperature liquid third material into a second mold for the temples, and demolding and trimming after a cool molding process;

Assembling the eyeglass frame and the temples together using screws, and assembling the lenses to form the eyeglass.

The first material comprises nylon, a temperature of the first material in liquid state is 220° C., and a temperature for maintaining the pasty state is controlled at 160° C.

The second material comprises the following components mixed by weight ratios: 76% of silica gel, 23.2% of latex, and 0.8% of catalyst, and the catalyst comprises an organic polysiloxane with at least two alkenyl groups per molecule. A temperature of the second material in liquid state is 160° C.

The third material comprises thermoplastic elastomers, and the temperature of the third material in liquid state is 220° C.

The cool molding is performed in water at 20° C.

Performance Test

The catalyst used in the nose pad acts on the surface of the silicone. Through the hundred grid test, the test results can be greater than ISO Grade 1 and ASTM Grade 4B, the damage in the grid area does not exceed 5%, and only part of the peeling occurs at the grid line.

It can be seen from the tests that the second material is formed by compounding silica gel, latex and catalyst, and the adhesive force thereof is good.

### Embodiment 2

A method for manufacturing the pair of eyeglasses, comprising the following steps:

Injecting a first material into the first mold, the first material is at high-temperature and in liquid state, and controlling the temperature of the first material so as to maintain the first material in a pasty state, a notch and a plurality of barbs are reserved on the eyeglass frame, continuously injecting a second material into the first mold, the second material is at high-temperature and in liquid state, so that at least one nose pad and the eyeglass frame can be fused by thermal fusion, completing secondary injection molding of at least one nose pad, and at least one nose pad is injected into the notch, the plurality of barbs are embedded in at least one nose pad to form fixation, and demolding and trimming after cool molding;

Injecting a high-temperature liquid third material into a second mold for the temples, and demolding and trimming after cool molding;

Assembling the eyeglass frame and the temples together with screws, and assembling the lenses to form the pair of eyeglasses.

The first material comprises nylon, the temperature of the first material at high-temperature and in liquid state is 230° C., and the temperature for maintaining the pasty state is controlled at 160° C.

The second material comprises the following components mixed by weight ratios: 82% of silica gel, 17% of latex, and 1% of catalyst, and the catalyst comprises an organic polysiloxane with at least two alkenyl groups per molecule. The temperature of the second material in liquid state is 170° C.

The third material comprises thermoplastic elastomers, and the temperature of the third material in liquid state is 230° C.

The cool molding is performed in water at 20° C.

### Embodiment 3

A method for manufacturing the pair of eyeglasses, comprising the following steps:

Injecting a first material into the first mold, the first material is at high-temperature and in liquid state, and controlling the temperature of the first material so as to maintain the first material in a pasty state, a notch and a reinforcing rib are reserved on the eyeglass frame, continuously injecting a second material into the first mold, the second material is at high-temperature and in liquid state, so that at least one nose pad and the eyeglass frame can be fused by thermal fusion, completing secondary injection molding of at least one nose pad, and at least one nose pad is injected into the notch, the reinforcing rib is embedded in at least one nose pad to form fixation, and demolding and trimming after cool molding;

Injecting a high-temperature liquid third material into a second mold for the temples, and demolding and trimming after cool molding;

Assembling the eyeglass frame and the temples together with screws, and assembling the lenses to form the pair of eyeglasses.

The first material comprises nylon, the temperature of the first material at high-temperature and in liquid state is 240° C., and the temperature for maintaining the pasty state is controlled at 170° C.

The second material comprises the following components mixed by weight ratios: 80% of silica gel, 18.2% of latex, and 0.8% of catalyst, and the catalyst comprises an organic polysiloxane with at least two alkenyl groups per molecule. The temperature of the second material in liquid state is 180° C.

The third material comprises thermoplastic elastomers, and the temperature of the third material in liquid state is 230° C.

The cool molding is performed in water at 20° C.

### Embodiment 4

A method for manufacturing the pair of eyeglasses, comprising the following steps:

Injecting a first material into the first mold, the first material is at high-temperature and in liquid state, and controlling the temperature of the first material so as to maintain the first material in a pasty state, a notch and a plurality of barbs are reserved on the eyeglass frame, continuously injecting a second material into the first mold, the second material is at high-temperature and in liquid state, so that at least one nose pad and the eyeglass frame can be fused by thermal fusion, completing secondary injection molding of at least one nose pad, and at least one nose pad is injected into the notch, the plurality of barbs are embedded in at least one nose pad to form fixation, and demolding and trimming after cool molding;

Injecting a high-temperature liquid third material into a second mold for the temples, and demolding and trimming after cool molding;

Assembling the eyeglass frame and the temples together with screws, and assembling the lenses to form the pair of eyeglasses.

The first material comprises nylon, the temperature of the first material in liquid state is 240° C., and the temperature for maintaining the pasty state is controlled at 165° C.

The second material comprises the following components mixed by weight ratios: 80% of silica gel, 19% of latex, and 1% of catalyst, and the catalyst comprises an organic polysiloxane with at least two alkenyl groups per molecule. The temperature of the second material in liquid state is 190° C.

The third material comprises thermoplastic elastomers, and the temperature of the third material in liquid state is 230° C.

The cool molding is performed in water at 20° C.

### Embodiment 5

A method for manufacturing the pair of eyeglasses, comprising the following steps:

Injecting a first material into the first mold, the first material is at high-temperature and in liquid state, and controlling the temperature of the first material so as to maintain the first material in a pasty state, a notch and a plurality of barbs are reserved on the eyeglass frame, continuously injecting a second material into the first mold, the second material is at high-temperature and in liquid state, so that at least one nose pad and the eyeglass frame can be fused by thermal fusion, completing secondary injection molding of at least one nose pad, and at least one nose pad is injected into the notch, the plurality of barbs are embedded in at least one nose pad to form fixation, and demolding and trimming after cool molding;

Injecting a high-temperature liquid third material into a second mold for the temples, and demolding and trimming after cool molding;

Assembling the eyeglass frame and the temples together with screws, and assembling the lenses to form the pair of eyeglasses.

The first material comprises nylon, the temperature of the first material at high-temperature and in liquid state is 250° C., and the temperature for maintaining the pasty state is controlled at 170° C.

The second material comprises the following components mixed by weight ratios: 80% of silica gel, 18.8% of latex, and 1.2% of catalyst, and the catalyst comprises an organic polysiloxane with at least two alkenyl groups per molecule. The temperature of the second material in liquid state is 190° C.

The third material comprises thermoplastic elastomers, and the temperature of the third material in liquid state is 240° C.

The cool molding is performed in water at 20° C.

### Embodiment 6

A method for manufacturing the pair of eyeglasses, comprising the following steps:

Injecting a first material into the first mold, the first material is at high-temperature and in liquid state, and controlling the temperature of the first material so as to maintain the first material in a pasty state, a notch and a reinforcing rib are reserved on the eyeglass frame, continuously injecting a second material into the first mold, the second material is at high-temperature and in liquid state, so that at least one nose pad and the eyeglass frame can be fused by thermal fusion, completing secondary injection molding of at least one nose pad, and at least one nose pad is injected into the notch, the reinforcing rib is embedded in at least one nose pad to form fixation, and demolding and trimming after cool molding;

Injecting a high-temperature liquid third material into a second mold for the temples, and demolding and trimming after cool molding;

Assembling the eyeglass frame and the temples together with screws, and assembling the lenses to form the pair of eyeglasses.

The first material comprises nylon, the temperature of the first material at high-temperature and in liquid state is 260° C., and the temperature for maintaining the pasty state is controlled at 170° C.

The second material comprises the following components mixed by weight ratios: 84% of silica gel, 15.2% of latex, and 0.8% of catalyst, and the catalyst comprises an organic polysiloxane with at least two alkenyl groups per molecule. The temperature of the second material in liquid state is 220° C.

The third material comprises thermoplastic elastomers, and the temperature of the third material in liquid state is 240° C.

The cool molding is performed in water at 20° C.

The foregoing descriptions are merely exemplary embodiments of the present disclosure, but are not intended to limit the present disclosure. Any modification, equivalent replacement, and improvement made within the spirit and principle of the present disclosure shall belong to the scope of protection of the present disclosure.

What is claimed is:

1. A pair of eyeglasses comprising:
an eyeglass frame surrounding a pair of lenses of the pair of the eyeglasses;
at least one nose pad arranged on the eyeglass frame, and molded integrally with the eyeglass frame, a material of the nose pad being different from a material of the eyeglass frame;
a reinforcing member extending out of one of the nose pad and a portion of the eyeglass frame corresponding to the nose pad; and
a matching member formed on the other one of the nose pad and the eyeglass frame, and the reinforcing member is coupled with the matching member.

2. The pair of eyeglasses according to claim 1, wherein the reinforcing member comprises a plurality of protrusions arranged at intervals, and the matching member has corresponding indentations to accommodate the plurality of barbs.

3. The pair of eyeglasses according to claim 2, wherein each of the protrusions comprises a post and a hook, the post is coupled to one of the nose pad and the eyeglass frame, and the hook is coupled to an end portion of the post away from one of the nose pad and the eyeglass frame.

4. The pair of eyeglasses according to claim 2, wherein the plurality of protrusions are arranged in at least two lines, and the protrusions of adjacent two of the lines are staggered.

5. The pair of eyeglasses according to claim 1, wherein the reinforcing member comprises at least one reinforcing rib, the at least one reinforcing rib extends along an extending direction of the portion of the eyeglass frame, and the matching member comprises corresponding indentations to accommodate the at least one reinforcing rib.

6. The pair of eyeglasses according to claim 1, wherein
the eyeglass frame further comprises at least one notch formed on the portion of the eyeglass frame, the notch comprises a first surface lower than a second surface of the eyeglass frame, the notch is configured to receiving the nose pad, and the reinforcing member is formed at the notch.

7. The pair of eyeglasses according to claim 1, further comprising a pair of temples rotatably disposed at the ends of both sides of the eyeglass frame; a pair of connection buckles; and an adjustment belt, wherein the pair of connection buckles are respectively arranged at one end of the pair of temples away from the eyeglass frame, and two ends of the adjustment belt are respectively connected to the pair of connection buckles.

8. The pair of eyeglasses according to claim 1, wherein the nose pad is formed by thermal fusion of latex, silica gel and organic polysiloxane catalyst.

9. The pair of eyeglasses according to claim 8, wherein the material of the nose pad comprises the following components mixed by weight ratios: 15-25% of latex, 75-85% of silica gel, and 0.8-1.2% of catalyst.

10. The pair of eyeglasses according to claim 9, wherein the catalyst comprises an organic polysiloxane with at least two alkenyl groups per molecule.

11. A method for manufacturing a pair of eyeglasses, the pair of eyeglasses comprising an eyeglass frame and at least one nose pad configured for supporting the eyeglass or the eyeglass frame on a nose of a wearer, the method comprising:
forming an eyeglass frame with a reinforcing member extending out a portion of the eyeglass frame by a molding injecting process, wherein the eyeglass frame is made of a first material; and
simultaneously forming the at least one nose pad corresponding to the portion of the eyeglass frame wherein the reinforcing member is positioned during the molding injection process, wherein the at least one nose pad is made of a second material different from the first material, the at least one node pad is formed with a matching member to couple to the reinforcing member.

12. The method for manufacturing the pair of eyeglasses according to claim 11, wherein forming an eyeglass frame with a reinforcing member extending out a portion of the eyeglass frame using a molding injecting process comprises:
providing a first mold configured for the eyeglass frame and the nose pad;
injecting the first material into the first mold, wherein the first material is in liquid state; and
controlling the temperature of the first material in the first mold to maintain the first material in a pasty state, and
wherein simultaneously forming the at least one nose pad corresponding to the portion of the eyeglass frame wherein the reinforcing member is positioned during the molding injection process comprises:
injecting the second material into the first mold, and fused the second material with the first material by hot melting to complete a secondary injection molding to form the nose pad, wherein the second material is in a liquid state, and
demolding and trimming after cool molding.

13. The method for manufacturing the pair of eyeglasses according to claim 11, wherein further comprising:
providing a second mold configured for temples;
injecting a third material into the second mold, wherein the third material is in a liquid state;
demolding and trimming after cool molding to form the temples; and
assembling the eyeglass frame and the temples together, and assembling a pair of lenses to form the pair of eyeglasses.

14. The method for manufacturing the pair of eyeglasses according to claim 12, wherein the first material comprises nylon, a temperature of the first material in liquid state is in a range of 220-265° C., and a temperature for maintaining the pasty state is controlled at a range of 160-170° C.

15. The method for manufacturing the pair of eyeglasses according to claim 11, wherein the second material comprises a following components mixed by weight ratio: 15-25% of latex, 75-85% of silica gel, and 0.8-1.2% of catalyst.

16. The method for manufacturing the pair of eyeglasses according to claim 15, wherein the second material comprises a following components mixed by weight ratio: 19% of latex, 80% of silica gel, and 1% of catalyst.

17. The method for manufacturing the pair of eyeglasses according to claim 15, wherein the catalyst comprises an organic polysiloxane with at least two alkenyl groups per molecule.

18. The method for manufacturing the pair of eyeglasses according to claim 12, wherein the temperature of the second material in the liquid state is in a range of 160-220° C.
